(19) United States
(12) Patent Application Publication
(10) Pub. No.: US 2026/0162412 A1
(43) Pub. Date: Jun. 11, 2026

(54) AUTOMATICALLY IDENTIFYING A CHECKPOINT OF A MACHINE LEARNING MODEL FOR DEPLOYMENT

(71) Applicant: Lemon Inc., Grand Cayman (KY)

(72) Inventors: Hao Kang, Los Angeles, CA (US); Xin Lu, Los Angeles, CA (US); Yumin Jia, Los Angeles, CA (US)

(21) Appl. No.: 18/972,539

(22) Filed: Dec. 6, 2024

(51) Int. Cl. G06V 10/776; G06V 10/74; G06V 10/774; G06V 10/98

(52) U.S. Cl. CPC G06V 10/776; G06V 10/761; G06V 10/774; G06V 10/98

(57) ABSTRACT

The present disclosure describes techniques for automatically identifying a checkpoint of a machine learning model for deployment. A plurality of checkpoints are generated during training the machine learning model. The machine learning model is trained on a set of training images. A plurality of subject images is generated by each of the plurality of checkpoints. Subject similarity and global difference between images in each pair of images are computed. Each pair of images comprises one of the set of training images and one of the plurality of subject images generated by each of the plurality of checkpoints. Image generation qualities of the plurality of checkpoints are evaluated based on the subject similarity and the global difference. The checkpoint of the machine learning model for deployment is automatically identified based on the evaluated image generation qualities.

### BACKGROUND

Machine learning models are increasingly being used across a variety of industries to perform a variety of different tasks. Such tasks may include audio or vision related tasks. Techniques for generating high-quality machine learning models are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for training a machine learning model in accordance with the present disclosure.

FIGS. 2A and 2B shows example subject images generated by checkpoints of a machine learning model in accordance with the present disclosure.

FIGS. 3A and 3B show examples for computing subject similarity between images in accordance with the present disclosure.

FIGS. 4A and 4B shows examples for computing global difference between images in accordance with the present disclosure.

FIGS. 5A and 5B show examples for evaluating image generation qualities of checkpoints of a machine learning model in accordance with the present disclosure.

FIGS. 6A and 6B show ranking examples for automatically identifying a checkpoint of a machine learning model for deployment in accordance with the present disclosure.

FIG. 7 shows an example process for automatically identifying a checkpoint of a machine learning model for deployment in accordance with the present disclosure.

FIG. 8 shows an example process for computing subject similarity between images in accordance with the present disclosure.

FIG. 9 shows an example process for computing global difference between images in accordance with the present disclosure.

FIG. 10 shows an example process for evaluating image generation qualities of checkpoints of a machine learning model in accordance with the present disclosure.

FIG. 11 shows an example process for automatically identifying a checkpoint of a machine learning model for deployment in accordance with the present disclosure.

FIG. 12 shows an example computing device which may be used to perform any of the techniques disclosed herein.

### DETAILED DESCRIPTION OF ILLUSTRATIVE EMBODIMENTS

A machine learning model, such as a diffusion model, can be fine-tuned using a limited set of images representing a specific subject to generate a plurality of checkpoints. Each checkpoint can be a saved version of the machine learning model at a specific training iteration or epoch. For example, each checkpoint can store the weights and parameters of the machine learning model at that specific training iteration or epoch. The ideal checkpoint for deployment may be the one that is able to generate images that preserve the identity of the subject while having diverse backgrounds. However, many of the checkpoints may be overfitted. Overfitting occurs when the machine learning model is unable to generalize and fits too closely to the training dataset. An overfitted model may generate images that consistently inherit the same properties (e.g., background, etc.) as the properties featured in the input images of the training dataset. Existing techniques for evaluating model checkpoints heavily rely on visual inspection, which is time-consuming and impractical for automated workflows or large-scale model deployment. As such, techniques for automatically evaluating model checkpoints are needed.

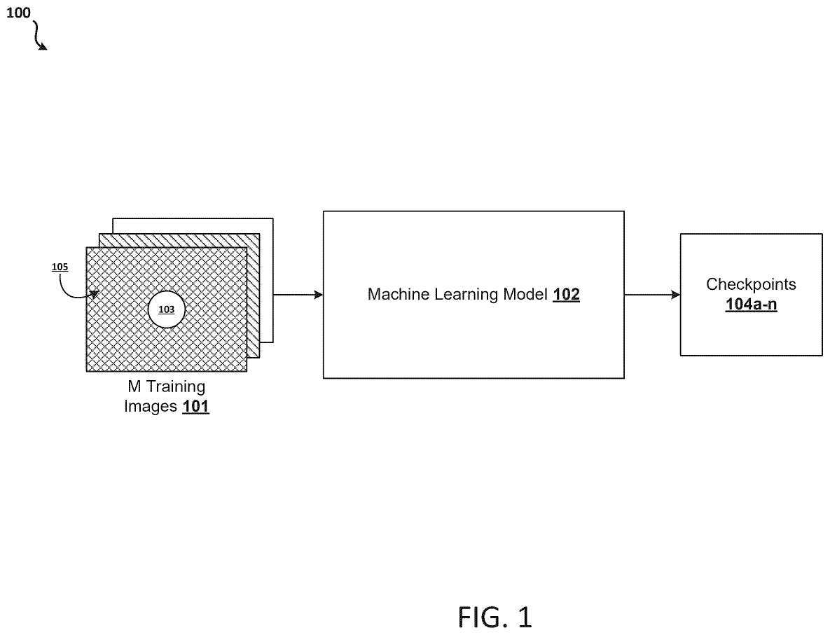

Described herein are techniques for automatically evaluating model checkpoints. FIG. 1 shows an example system 100 for evaluating image generation qualities of checkpoints of a machine learning model to automatically identifying a checkpoint for deployment in accordance with the present disclosure. A plurality of checkpoints 104a-n can be generated by fine-tuning the machine learning model 102. The machine learning model 102 can include any machine learning model, including but not limited to a large vision foundation model. The large vision foundation model can be pre-trained to generate images, such as new images from scratch. The large vision foundation model can include a stable diffusion model or any other large vision foundation model.

The plurality of checkpoints 104a-n can be generated during training the machine learning model 102 for subject identity preservation while preventing overfitting. For example, the plurality of checkpoints 104a-n can be generated by finetuning the machine learning model 102 based on a set of training images 101. The set of training images 101 can include M images, where M is any integer number greater than zero. The set of training images 101 can include at least one image depicting a subject 103 (e.g., a user, a person, an animal, an object, etc.). Each image in the set of training images 101 can comprise or depict the identity information of the subject 103, such as facial information and/or features that can be used to identify the subject. Each image in the set of training images 101 can comprise or depict remaining information 105. The remaining information 105 can include background information and/or structural information. The background information can include information indicating the elements or details in the area surrounding the subject 103. The structural information can include one or more of pose information, clothing information, spatial and/or depth information, outline information indicating the outlines of objects in the image, and/or any other type of structural information.

Each of the plurality of checkpoints 104a-n can comprise a saved version of the machine learning model 102 at a specific training iteration or epoch. Each of the plurality of checkpoints 104a-n can store the weights and parameters of the machine learning model 102 at that specific training iteration or epoch. For example, the checkpoint 104a may comprise a saved version of the machine learning model 102 after the initial 100 iterations of training on the set of training images 101, the checkpoint 104b may comprise a saved version of the machine learning model 102 after the next 100 iterations (e.g., after 200 total iterations) of training on the set of training images 101, the checkpoint 104c may comprise a saved version of the machine learning model 102 after the next 100 iterations (e.g., after 300 total iterations) of training on the set of training images 101.

Each of the plurality of checkpoints 104a-n can be configured to generate images. The ideal checkpoint among the plurality of checkpoints 104a-n for deployment may be the checkpoint that is able to generate images that both depict the same subject as the subject depicted in the set of training images 101 (e.g., maintain the identity of the subject) and have diverse backgrounds. In other words, an ideal checkpoint among the plurality of checkpoints 104a-n is one that is not overfitted. It can be difficult to manually identify the ideal checkpoint for deployment, especially as the quantity of checkpoints in the plurality of checkpoints 104a-n increases.

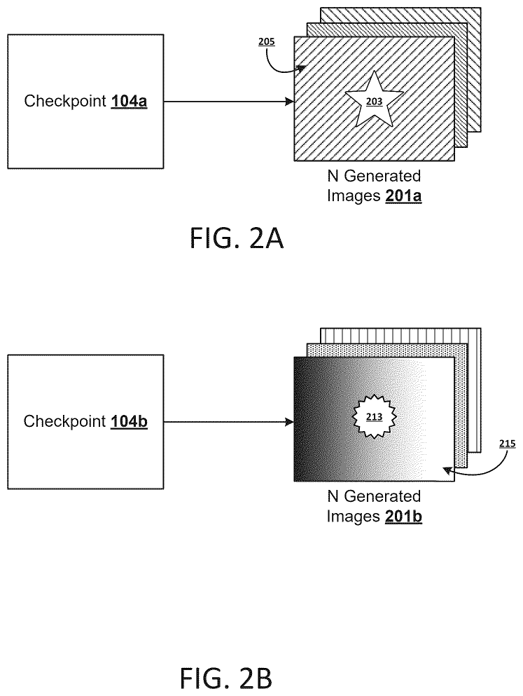

A checkpoint among the plurality of checkpoints 104a-n for deployment can be automatically identified based on generating a plurality of subject images by each of the plurality of checkpoints 104a-n. FIGS. 2A and 2B show example subject images generated by the checkpoint 104a and the checkpoint 104b respectively in accordance with the present disclosure. While FIGS. 2A and 2B only show example subject images generated by the checkpoint 104a and the checkpoint 104b, it should be appreciated that each of the plurality of checkpoints 104a-n can similarly generate subject images.

The checkpoint 104a can generate a set of subject images 201a. The checkpoint 104a can generate the set of subject images 201a based on (e.g., in response to) being prompted to generate the set of subject images 201a. Alternatively, the checkpoint 104a can automatically generate the set of subject images 201a without being prompted to do so. The set of subject images 201a can include N images, where N is any integer number greater than zero. N can be different from, or the same as, M.

The set of subject images 201a can include at least one image depicting a subject 203 (e.g., a user, a person, an animal, an object, etc.). Each image in the set of subject images 201a can comprise or depict the identity information of the subject 203, such as facial information and/or features that can be used to identify the subject. Each image in the set of subject images 201a can comprise or depict remaining information 205. The remaining information 205 can include background information and/or structural information. The background information can include information indicating the elements or details in the area surrounding the subject 203. The structural information can include one or more of pose information, clothing information, spatial and/or depth information, outline information indicating the outlines of objects in the image, and/or any other type of structural information.

The checkpoint 104b can generate the set of subject images 201b based on (e.g., in response to) being prompted to generate the set of subject images 201b. Alternatively, the checkpoint 104b can automatically generate the set of subject images 201b without being prompted to do so. The set of subject images 201b can include N images, where N is any integer number greater than zero. N can be different from, or the same as, M.

The set of subject images 201b can include at least one image depicting a subject 213 (e.g., a user, a person, an animal, an object, etc.). Each image in the set of subject images 201b can comprise or depict the identity information of the subject 213, such as facial information and/or features that can be used to identify the subject. Each image in the set of subject images 201b can comprise or depict remaining information 215. The remaining information 215 can include background information and/or structural information. The background information can include information indicating the elements or details in the area surrounding the subject 213. The structural information can include one or more of pose information, clothing information, spatial and/or depth information, outline information indicating the outlines of objects in the image, and/or any other type of structural information.

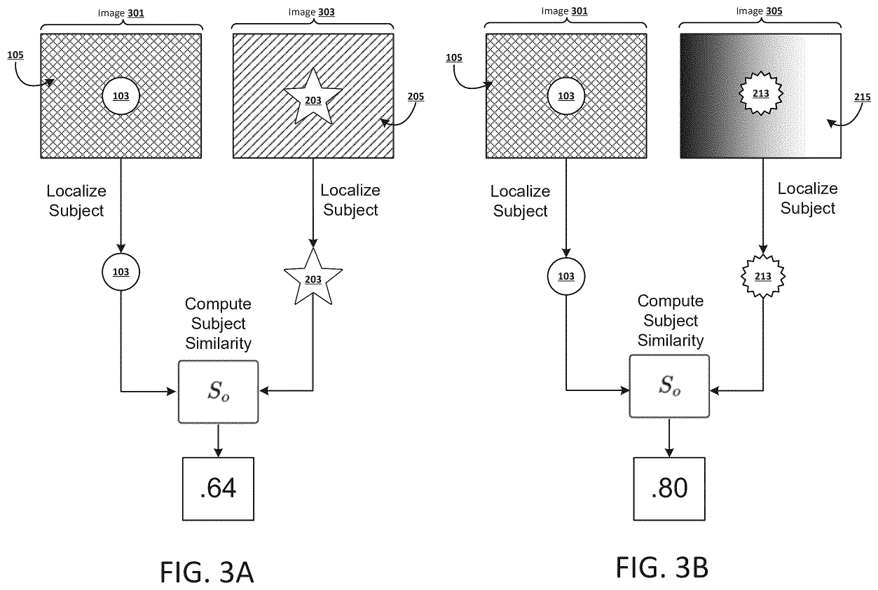

A checkpoint among the plurality of checkpoints 104a-n for deployment can be automatically identified based at least in part on computing subject similarity between each pair of images, where each pair of images comprises one of the set of training images 101 and one of the subject images generated by each of the plurality of checkpoints. FIGS. 3A and 3B show examples for computing subject similarity between images in accordance with the present disclosure. To compute a subject similarity S₀ between an image 301 from the set of training images 101 and an image 303 from the set of subject images 201a, the subject 103 can be detected and extracted from the image 301 and the subject 203 can be detected and extracted from the image 303. The subject 103 and the subject 203 can be localized or extracted using any suitable subject recognition process and/or extraction technique.

The extracted subject 103 can be compared to the extracted subject 203 to determine how similar the subject 103 is to the subject 203. To compare the extracted subject 103 to the extracted subject 203, the extracted subject 103 can be converted (e.g., encoded) into a first set of features (e.g., a first feature vector) representative of the extracted subject 103. The extracted subject 203 can similarly be converted (e.g., encoded) into a second set of features (e.g., a second feature vector) representative of the extracted subject 203. The first set of features can be compared to the second set of features to determine a similarity between the first set of features and the second set of features.

The similarity between the first set of features and the second set of features can be determined using any suitable metric, including cosine similarity, Manhattan distance, Euclidean distance, Minkowski distance, Jaccard similarity, or any other similarity metric. The similarity between the first set of features and the second set of features can be indicative of the subject similarity between the image 301 and the image 303. In the example of FIG. 3A, the subject similarity between the image 301 from the set of training images 101 and the image 303 from the set of subject images 201a has a value of 0.64.

To compute a subject similarity S₀ between the image 301 from the set of training images 101 and an image 305 from the set of subject images 201c, the subject 103 can be detected and extracted from the image 301 and the subject 213 can be detected and extracted from the image 305. The subject 103 and the subject 213 can be localized or extracted using any suitable subject recognition process and/or extraction technique.

The extracted subject 103 can be compared to the extracted subject 213 to determine how similar the subject 103 is to the subject 213. To compare the extracted subject 103 to the extracted subject 213, the extracted subject 103 can be converted (e.g., encoded) into a first set of features (e.g., a first feature vector) representative of the extracted subject 103. The extracted subject 213 can similarly be converted (e.g., encoded) into a second set of features (e.g., a second feature vector) representative of the extracted subject 213. The first set of features can be compared to the second set of features to determine a similarity between the first set of features and the second set of features.

The similarity between the first set of features and the second set of features may be determined using any suitable metric, including cosine similarity, Manhattan distance, Euclidean distance, Minkowski distance, Jaccard similarity, or any other similarity metric. The similarity between the first set of features and the second set of features can be indicative of the subject similarity between the image 301 and the image 305. In the example of FIG. 3B, the subject similarity between the image 301 from the set of training images 101 and the image 305 from the set of subject images 201a has a value of 0.80, indicating that the subject 103 is more similar to the subject 213 than the subject 203 (e.g., 0.80 is greater than 0.64).

This process for computing subject similarity can be repeated for each pair of images, such that a subject similarity between each image in the set of training images 101 and each of the subject images generated by each of the plurality of checkpoints 104a-n is calculated. For example, a subject similarity between each image in the set of training images 101 and each image in the set of subject images 201a can be calculated. Likewise, a subject similarity between each image in the set of training images 101 and each image in the set of subject images 201b can be calculated. A subject similarity between each image in the set of training images 101 and each image in the set of subject images generated by the checkpoint 104c can be calculated, and so on.

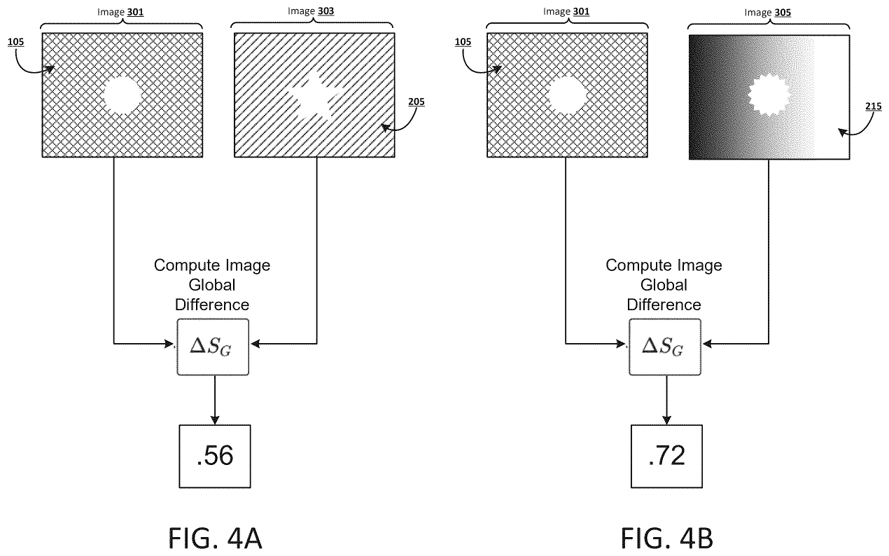

A checkpoint among the plurality of checkpoints 104a-n for deployment can be automatically identified based at least in part on computing a global difference between each pair of images, where each pair of images comprises one of the set of training images 101 and one of the subject images generated by each of the plurality of checkpoints. FIGS. 4A and 4B show examples for computing global difference between images in accordance with the present disclosure. To compute a global difference ΔS_{G} between the image 301 from the set of training images 101 and the image 303 from the set of subject images 201a, the subject 103 can be removed from the image 301 such that only the remainder information 105 (e.g., background and/or structural information) remains. The subject 203 can be removed from the image 303 such that only the remainder information 205 (e.g., background and/or structural information) remains.

The remainder information 105 can be compared to the remainder information 205 to determine how different the remainder information 105 is from the remainder information 205. To compare the remainder information 105 to the remainder information 205, the remainder information 105 can be converted (e.g., encoded) into a first set of features (e.g., a first feature vector) representative of the remainder information 105. The remainder information 205 can similarly be converted (e.g., encoded) into a second set of features (e.g., a second feature vector) representative of the remainder information 205. The first set of features can be compared to the second set of features to determine a difference between the first set of features and the second set of features.

The difference between the first set of features and the second set of features may be determined using any suitable metric, including cosine similarity, Manhattan distance, Euclidean distance, Minkowski distance, Jaccard similarity, or any other similarity metric. The difference between the first set of features and the second set of features may be indicative of the global difference between the image 301 and the image 303. In the example of FIG. 4A, the global difference between the image 301 and the image 303 has a value of 0.56.

To compute the global difference ΔS_{G} between the image 301 from the set of training images 101 and the image 305 from the set of subject images 201b, the subject 103 can be removed from the image 301 such that only the remainder information 105 (e.g., background and/or structural information) remains. The subject 213 can be removed from the image 305 such that only the remainder information 215 (e.g., background and/or structural information) remains.

The remainder information 105 can be compared to the remainder information 215 to determine how different the remainder information 105 is from the remainder information 215. To compare the remainder information 105 to the remainder information 215, the remainder information 105 can be converted (e.g., encoded) into a first set of features (e.g., a first feature vector) representative of the remainder information 105. The remainder information 215 can similarly be converted (e.g., encoded) into a second set of features (e.g., a second feature vector) representative of the remainder information 215. The first set of features can be compared to the second set of features to determine a difference between the first set of features and the second set of features.

The difference between the first set of features and the second set of features may be determined using any suitable metric, including cosine similarity, Manhattan distance, Euclidean distance, Minkowski distance, Jaccard similarity, or any other similarity metric. The difference between the first set of features and the second set of features may be indicative of the global difference between the image 301 and the image 305. In the example of FIG. 4B, the global difference between the image 301 and the image 305 has a value of 0.72, indicating that the remainder information 105 is more different from the remainder information 215 than it is from the remainder information 205 (e.g., 0.72 is greater than 0.56).

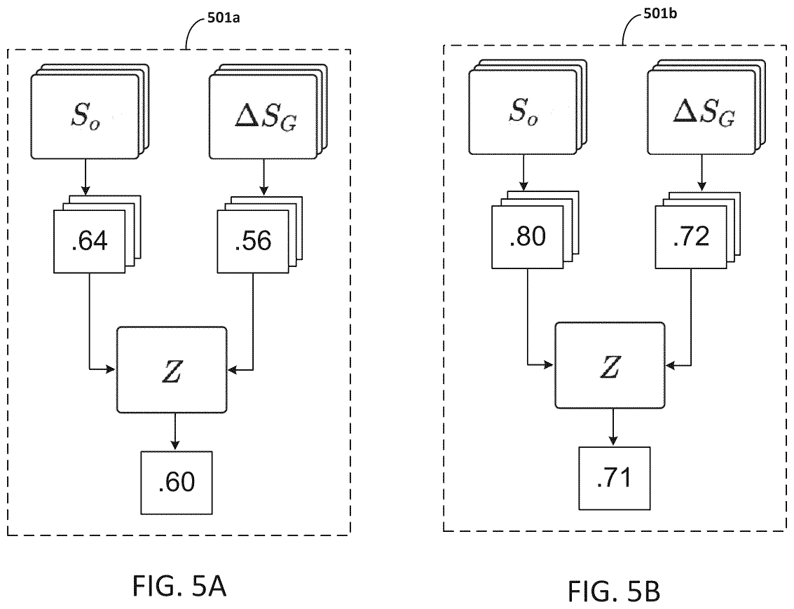

Image generation qualities of the plurality of checkpoints 104a-n can be evaluated based on the subject similarity and the global difference between each pair of images. FIGS. 5A and 5B shows examples for evaluating the image generation qualities of checkpoints 104a-n of the machine learning model 102. The image generation qualities of the plurality of checkpoints 104a-n can be evaluated by applying a scoring function Z that accounts for the subject similarity S₀ and the global difference ΔS_{G} in each pair of images.

A calculation 501a can be performed to evaluate the image generation quality of checkpoint 104a. All of the subject similarity scores S₀ and all of the global difference scores ΔS_{G} between the images in the set of training images 101 and the images from the set of subject images 201a generated by the checkpoint 104a can be input into the scoring function Z. The value of the scoring function Z can indicate an overall score associated with the checkpoint 104a. In embodiments,

$$Z = \frac{1}{N \times M} {\sum }_{i = 1}^{N} {\sum }_{j = 1}^{M} [ α {S}_{0} ( i , j ) + ( 1 - α ) Δ {S}_{g} ( i , j ) ] ,$$

wherein N represents a quantity of images in the set of subject images 201a generated by the checkpoint 104a, M represents a quantity of images in the set of training images 101, S₀ represents the subject similarity in each pair of images, ΔS_{g} represents the global difference in each pair of images, each pair of images comprises an image from the set of training images 101 and an image from the set of subject images 201a generated by the checkpoint 104a, and a is a predetermined constant. The value of a can be selected by a user. In the example of FIG. 5A, the overall score for the checkpoint 104a has a value of 0.60.

Similarly, a calculation 501b can be performed to evaluate the image generation quality of checkpoint 104b. All of the subject similarity scores S₀ and all of the global difference scores ΔS_{G} between the images in the set of training images 101 and the images from the set of subject images 201b generated by the checkpoint 104b can be input into the scoring function Z. The value of the scoring function Z can indicate an overall score associated with the checkpoint 104b. In embodiments,

$$Z = \frac{1}{N \times M} {\sum }_{i = 1}^{N} {\sum }_{j = 1}^{M} [ α {S}_{0} ( i , j ) + ( 1 - α ) Δ {S}_{g} ( i , j ) ] ,$$

wherein N represents a quantity of images in the set of subject images 201b generated by the checkpoint 104b, M represents a quantity of images in the set of training images 101, S₀ represents the subject similarity in each pair of images, ΔS_{g} represents the global difference in each pair of images, each pair of images comprises an image from the set of training images 101 and an image from the set of subject images 201b generated by the checkpoint 104b, and a is a predetermined constant. The value of a can be selected by a user. In the example of FIG. 5B, the overall score for the checkpoint 104b has a value of 0.71. An overall score can similarly be generated for each of the remaining checkpoints among the plurality of checkpoints 104a-n.

A checkpoint from the plurality of checkpoints 104a-n for deployment can be automatically identified based on the evaluated image generation qualities of the plurality of checkpoints 104a-n. To automatically identify the checkpoint for deployment, the plurality of checkpoints 104a-n can be ranked based on the overall scores. The checkpoint with the highest overall score can be the checkpoint that is best able to generate images that maintain the identity of the subject 103 in the set of training images 101 while also having diverse remaining information (e.g., diverse backgrounds). Conversely, the checkpoint with the lowest overall score can be the checkpoint that is most over-fitted (e.g., least able to generate images that maintain the identity of the subject 103 in the set of training images 101 while having diverse remaining information (e.g., diverse backgrounds)).

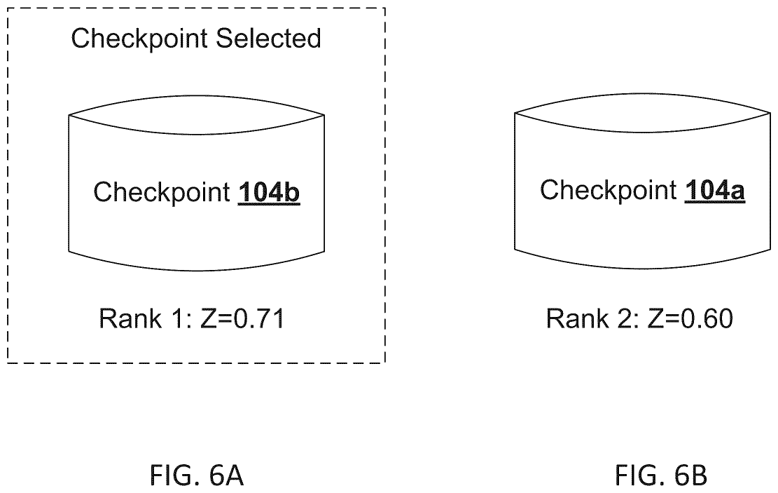

The checkpoint with the highest overall score can be automatically identified and/or selected for deployment. For example, as shown in FIGS. 6A and 6B, the checkpoint 104b may be ranked higher than the checkpoint 104a if checkpoint 104b is associated with a higher overall score (e.g., 0.71) than the checkpoint 104a (e.g., 0.60). If the checkpoint 104b is ranked higher than the checkpoint 104a (and all of the other checkpoints 104c-n), the checkpoint 104b can be automatically identified and/or selected for deployment. In this manner, the best checkpoint does not need to be manually identified.

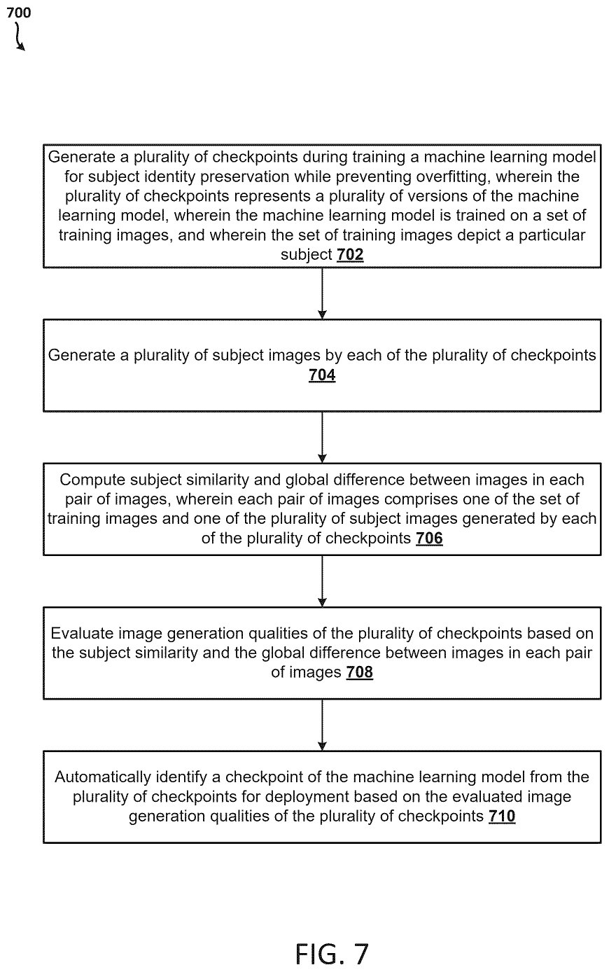

FIG. 7 illustrates an example process 700 for automatically identifying a checkpoint of a machine learning model for deployment. Although depicted as a sequence of operations in FIG. 7, those of ordinary skill in the art will appreciate that various embodiments may add, remove, reorder, or modify the depicted operations.

At 702, a plurality of checkpoints (e.g., checkpoints 104a-n) can be generated. The plurality of checkpoints can be generated during training a machine learning model (e.g., machine learning model 102) for subject identity preservation while preventing overfitting. The machine learning model can be trained on a set of training images. The set of training images can depict a particular subject (e.g., a user, a person, an animal, an object, etc.). The set of training images can include M images, where M is any integer number greater than zero. The plurality of checkpoints can represent a plurality of versions of the machine learning model. For example, each of the plurality of checkpoints can comprise a saved version of the machine learning model at a specific training iteration or epoch. Each of the plurality of checkpoints can store the weights and parameters of the machine learning model at that specific training iteration or epoch.

At 704, a plurality of subject images (e.g., subject images 201a and/or subject images 201b) can be generated by each of the plurality of checkpoints. Each of the plurality of checkpoints can generate a corresponding set of subject images based on (e.g., in response to) being prompted to generate the set of subject images. Alternatively, each of the plurality of checkpoints can automatically generate the set of subject images without being prompted to do so. Each set of subject images can include N images, where N is any integer number greater than zero. N can be different from, or the same as, M. At 706, a subject similarity and a global difference between images in each pair of images can be computed. Each pair of images can include one image from the set of training images and one image from the plurality of subject images generated by each of the plurality of checkpoints.

At 708, an image generation quality of each of the plurality of checkpoints can be evaluated. The image generation qualities of the plurality of checkpoints can be evaluated based on the subject similarity and the global difference between images in each pair of images. At 710, a checkpoint from the plurality of checkpoints can be automatically identified for deployment. The checkpoint from the plurality of checkpoints can be automatically identified based on the evaluated image generation qualities of the plurality of checkpoints. The checkpoint that is best able to generate images that maintain the identity of the subject in the set of training images while also having diverse remaining information (e.g., diverse backgrounds) can be the checkpoint that is automatically identified for deployment.

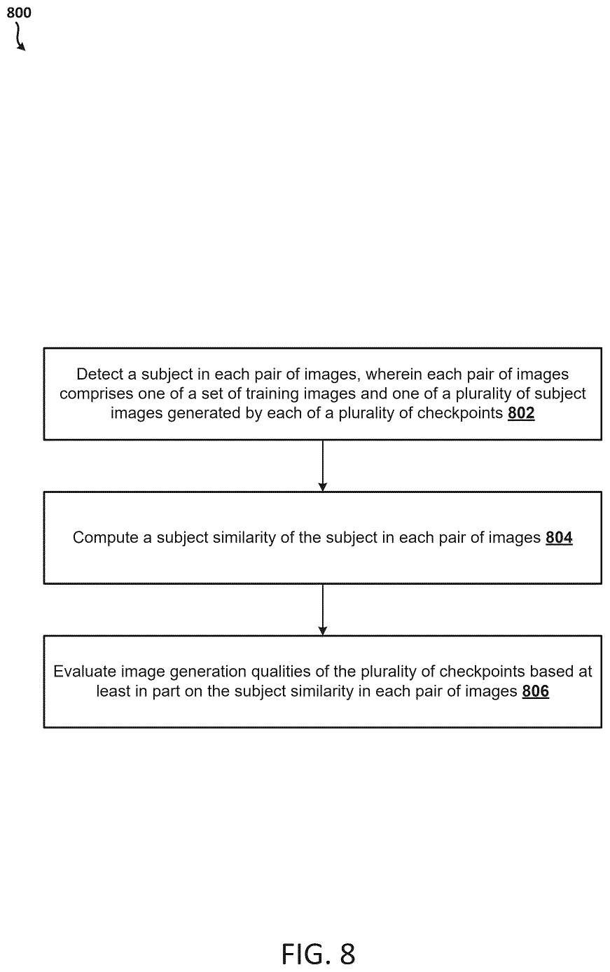

FIG. 8 illustrates an example process 800 for computing subject similarity between images. Although depicted as a sequence of operations in FIG. 8, those of ordinary skill in the art will appreciate that various embodiments may add, remove, reorder, or modify the depicted operations.

A plurality of checkpoints (e.g., checkpoints 104a-n) can be generated. The plurality of checkpoints can be generated during training a machine learning model (e.g., machine learning model 102) for subject identity preservation while preventing overfitting. The machine learning model can be trained on a set of training images. The set of training images can depict a particular subject (e.g., a user, a person, an animal, an object, etc.). The plurality of checkpoints can represent a plurality of versions of the machine learning model. For example, each of the plurality of checkpoints can comprise a saved version of the machine learning model at a specific training iteration or epoch. Each of the plurality of checkpoints can store the weights and parameters of the machine learning model at that specific training iteration or epoch. A plurality of subject images (e.g., subject images 201a and/or subject images 201b) can be generated by each of the plurality of checkpoints.

At 802, subject(s) can be detected in each pair of images. Each pair of images can include one image from the set of training images and one image from the plurality of subject images generated by each of the plurality of checkpoints. The subject(s) can be extracted from each pair of images. At 804, a subject similarity of the subject(s) in each pair of images can be computed. For example, the detected and/or extracted subject(s) can be compared to determine how similar they are to each other. To compare the detected and/or extracted subjects, the detected and/or extracted subjects can be converted (e.g., encoded) into a sets of features (e.g., feature vectors). The sets of features can be compared to determine a similarity between the sets of features. The similarity between the first set of features and the second set of features can be determined using any suitable metric, including cosine similarity, Manhattan distance, Euclidean distance, Minkowski distance, Jaccard similarity, or any other similarity metric. The similarity between the sets of features can be indicative of the subject similarity between pair of images. At 806, image generation qualities of the plurality of checkpoints can be evaluated based at least in part on the subject similarity in each pair of images.

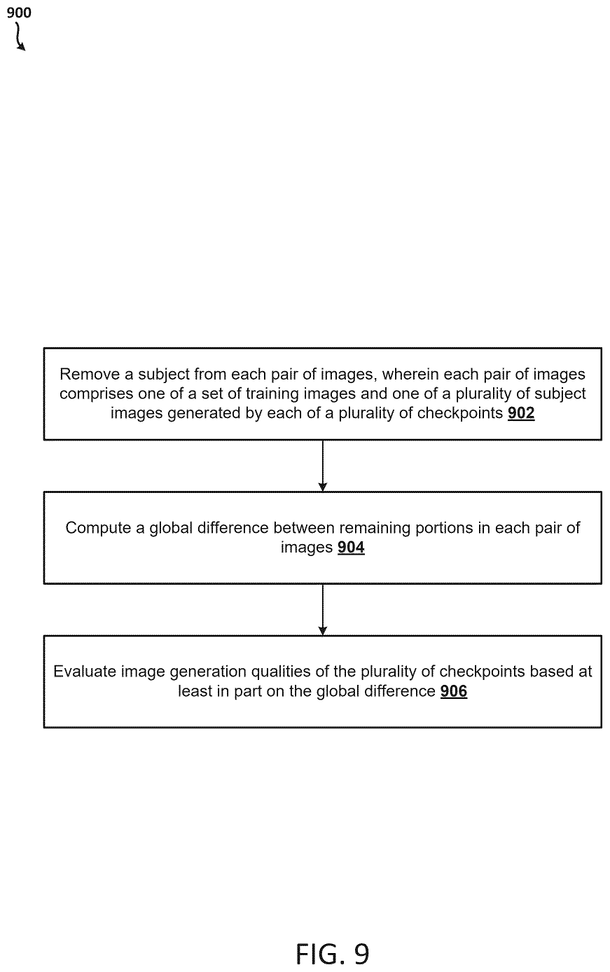

FIG. 9 illustrates an example process 900 for computing global difference between images. Although depicted as a sequence of operations in FIG. 9, those of ordinary skill in the art will appreciate that various embodiments may add, remove, reorder, or modify the depicted operations.

A plurality of checkpoints (e.g., checkpoints 104a-n) can be generated. The plurality of checkpoints can be generated during training a machine learning model (e.g., machine learning model 102) for subject identity preservation while preventing overfitting. The machine learning model can be trained on a set of training images. The set of training images can depict a particular subject (e.g., a user, a person, an animal, an object, etc.). The plurality of checkpoints can represent a plurality of versions of the machine learning model. For example, each of the plurality of checkpoints can comprise a saved version of the machine learning model at a specific training iteration or epoch. Each of the plurality of checkpoints can store the weights and parameters of the machine learning model at that specific training iteration or epoch. A plurality of subject images (e.g., subject images 201a and/or subject images 201b) can be generated by each of the plurality of checkpoints.

At 902, a subject can be removed from each image in each pair of images. Each pair of images can include one image from the set of training images and one image from the plurality of subject images generated by each of the plurality of checkpoints. The subject can be removed from each image such that only the remainder information (e.g., background and/or structural information) remains. At 904, a global difference between remaining portions in each pair of images can be computed. The global difference between the remaining portions in each pair of images can be computed may be determined using any suitable metric, including cosine similarity, Manhattan distance, Euclidean distance, Minkowski distance, Jaccard similarity, or any other similarity metric. At 906, image generation qualities of the plurality of checkpoints can be evaluated based at least in part on the global difference between each pair of images.

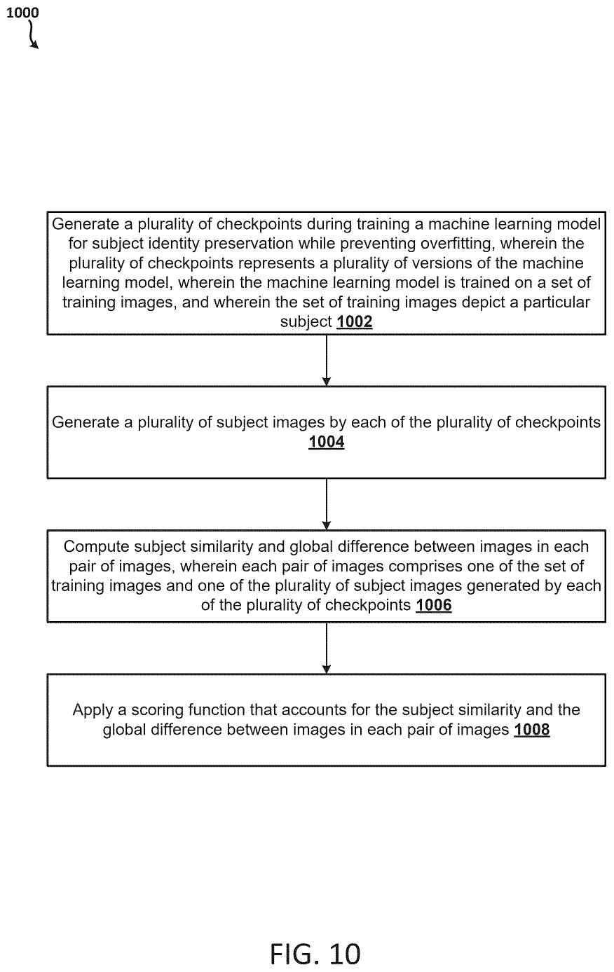

FIG. 10 illustrates an example process 1000 for evaluating image generation qualities of checkpoints of a machine learning model. Although depicted as a sequence of operations in FIG. 10, those of ordinary skill in the art will appreciate that various embodiments may add, remove, reorder, or modify the depicted operations.

At 1002, a plurality of checkpoints (e.g., checkpoints 104a-n) can be generated. The plurality of checkpoints can be generated during training a machine learning model (e.g., machine learning model 102) for subject identity preservation while preventing overfitting. The machine learning model can be trained on a set of training images. The set of training images can depict a particular subject (e.g., a user, a person, an animal, an object, etc.). The plurality of checkpoints can represent a plurality of versions of the machine learning model. For example, each of the plurality of checkpoints can comprise a saved version of the machine learning model at a specific training iteration or epoch. Each of the plurality of checkpoints can store the weights and parameters of the machine learning model at that specific training iteration or epoch.

At 1004, a plurality of subject images (e.g., subject images 201a and/or subject images 201b) can be generated by each of the plurality of checkpoints. Each of the plurality of checkpoints can generate a corresponding set of subject images based on (e.g., in response to) being prompted to generate the set of subject images. Alternatively, each of the plurality of checkpoints can automatically generate the set of subject images without being prompted to do so. Each set of subject images can include N images, where N is any integer number greater than zero. N can be different from, or the same as, M. At 1006, a subject similarity and a global difference between images in each pair of images can be computed. Each pair of images can include one image from the set of training images and one image from the plurality of subject images generated by each of the plurality of checkpoints.

Image generation qualities of the plurality of checkpoints can be evaluated based on the subject similarity and the global difference between each pair of images. The image generation qualities of the plurality of checkpoints can be evaluated by applying a scoring function Z that accounts for the subject similarity and the global difference between images in each pair of images. At 1008, a scoring function that accounts for the subject similarity and the global difference between each pair of images can be applied. In embodiments,

$$Z = \frac{1}{N \times M} {\sum }_{i = 1}^{N} {\sum }_{j = 1}^{M} [ α {S}_{0} ( i , j ) + ( 1 - α ) Δ {S}_{g} ( i , j ) ] ,$$

wherein N represents a quantity of images in the set of subject images generated by the checkpoint, M represents a quantity of images in the set of training images, S₀ represents the subject similarity between images in each pair of images, ΔS_{g} represents the global difference between images in each pair of images, and a is a predetermined constant. The value of a can be selected by a user.

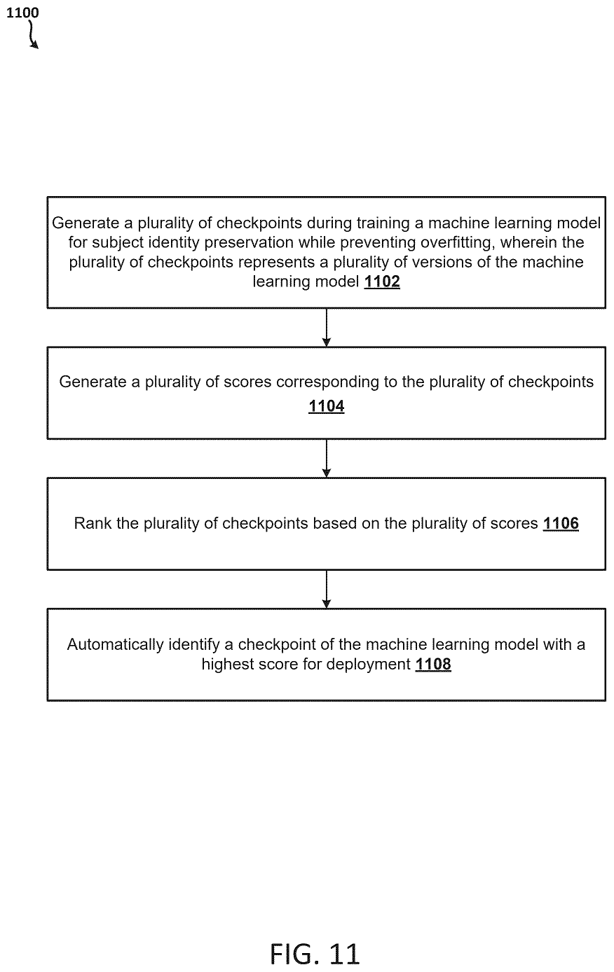

FIG. 11 illustrates an example process 1100 for automatically identifying a checkpoint of a machine learning model for deployment. Although depicted as a sequence of operations in FIG. 11, those of ordinary skill in the art will appreciate that various embodiments may add, remove, reorder, or modify the depicted operations.

At 1102, a plurality of checkpoints (e.g., checkpoints 104a-n) can be generated. The plurality of checkpoints can be generated during training a machine learning model (e.g., machine learning model 102) for subject identity preservation while preventing overfitting. The machine learning model can be trained on a set of training images. The set of training images can depict a particular subject (e.g., a user, a person, an animal, an object, etc.). The plurality of checkpoints can represent a plurality of versions of the machine learning model. For example, each of the plurality of checkpoints can comprise a saved version of the machine learning model at a specific training iteration or epoch. Each of the plurality of checkpoints can store the weights and parameters of the machine learning model at that specific training iteration or epoch.

At 1104, a plurality of scores corresponding to the plurality of checkpoints can be generated. The plurality of scores can be generated by applying a scoring function Z that accounts for the subject similarity and the global difference between each pair of images. Each pair of images can include one image from the set of training images and one image from the plurality of subject images generated by each of the plurality of checkpoints. In embodiments,

$$Z = \frac{1}{N \times M} {\sum }_{i = 1}^{N} {\sum }_{j = 1}^{M} [ α {S}_{0} ( i , j ) + ( 1 - α ) Δ {S}_{g} ( i , j ) ] ,$$

wherein N represents a quantity of images in the set of subject images generated by the checkpoint, M represents a quantity of images in the set of training images, S₀ represents the subject similarity between images in each pair of images, ΔS_{g} represents the global difference between images in each pair of images, and a is a predetermined constant. The value of a can be selected by a user.

At 1106, the plurality of checkpoints can be ranked. The plurality of checkpoints can be ranked based on the plurality of scores. At 1108, a checkpoint of the machine learning model with a highest score can be automatically identified for deployment. The checkpoint with a highest score can be the checkpoint that is best able to generate images that maintain the identity of the subject in the set of training images while also having diverse remaining information (e.g., diverse backgrounds).

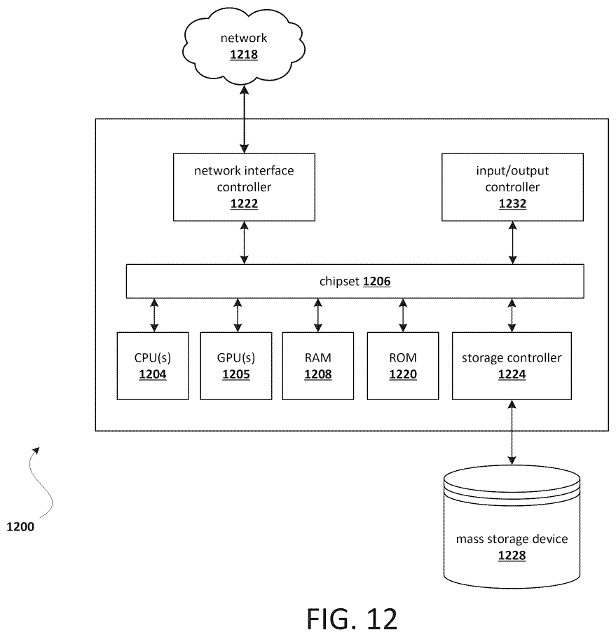

FIG. 12 illustrates a computing device that may be used in various aspects, such as the model(s), components, and/or devices depicted in FIGS. 1-5. With regard to FIGS. 1-5, any or all of the components may each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN). The chipset 1206 may include functionality for providing network connectivity through a network interface controller (NIC) 1222, such as a gigabit Ethernet adapter. A NIC 1222 may be capable of connecting the computing device 1200 to other computing nodes over a network 1218. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. The mass storage device 1228 may comprise a management component 1210. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on the mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of automatically identifying a checkpoint of a machine learning model for deployment, comprising:
generating a plurality of checkpoints during training the machine learning model for subject identity preservation while preventing overfitting, wherein the plurality of checkpoints represents a plurality of versions of the machine learning model, wherein the machine learning model is trained on a set of training images, and wherein the set of training images depict a particular subject;
generating a plurality of subject images by each of the plurality of checkpoints;
computing subject similarity and global difference between images in each pair of images, wherein each pair of images comprises one of the set of training images and one of the plurality of subject images generated by each of the plurality of checkpoints;
evaluating image generation qualities of the plurality of checkpoints based on the subject similarity and the global difference between images in each pair of images; and
automatically identifying the checkpoint of the machine learning model from the plurality of checkpoints for deployment based on the evaluated image generation qualities of the plurality of checkpoints.

2. The method of claim 1, further comprising:
detecting the particular subject in each pair of images; and
computing the subject similarity of the particular subject in each pair of images.

3. The method of claim 1, further comprising:
removing the particular subject from each pair of images; and
computing the global difference between remaining portions in each pair of images.

4. The method of claim 1, further comprising:
evaluating the image generation qualities of the plurality of checkpoints by applying a scoring function that accounts for the subject similarity and the global difference between each pair of images.

5. The method of claim 4, wherein the scoring function is represented by
$$\frac{1}{N \times M} {\sum }_{i = 1}^{N} {\sum }_{j = 1}^{M} [ α {S}_{0} ( i , j ) + ( 1 - α ) Δ {S}_{g} ( i , j ) ] ,$$
wherein N represents a quantity of images in the plurality of subject images generated by each of the plurality of checkpoints, M represents a quantity of images in the set of training images, S₀ represents the subject similarity between images in each pair of images, ΔS_{g} represents the global difference between images in each pair of images, and a represents a predetermined constant.

6. The method of claim 4, further comprising:
generating a plurality of scores corresponding to the plurality of checkpoints;
ranking the plurality of checkpoints based on the plurality of scores.

7. The method of claim 4, further comprising:
automatically identifying the checkpoint of the machine learning model with a highest score for deployment.

8. A system of automatically identifying a checkpoint of a machine learning model for deployment, comprising:
at least one processor; and
at least one memory communicatively coupled to the at least one processor and comprising computer-readable instructions that upon execution by the at least one processor cause the at least one processor to perform operations comprising:
generating a plurality of checkpoints during training the machine learning model for subject identity preservation while preventing overfitting, wherein the plurality of checkpoints represents a plurality of versions of the machine learning model, wherein the machine learning model is trained on a set of training images, and wherein the set of training images depict a particular subject;
generating a plurality of subject images by each of the plurality of checkpoints;
computing subject similarity and global difference between images in each pair of images, wherein each pair of images comprises one of the set of training images and one of the plurality of subject images generated by each of the plurality of checkpoints;
evaluating image generation qualities of the plurality of checkpoints based on the subject similarity and the global difference between images in each pair of images; and
automatically identifying the checkpoint of the machine learning model from the plurality of checkpoints for deployment based on the evaluated image generation qualities of the plurality of checkpoints.

9. The system of claim 8, the operations further comprising:
detecting the particular subject in each pair of images; and
computing the subject similarity of the particular subject in each pair of images.

10. The system of claim 8, the operations further comprising:
removing the particular subject from each pair of images; and
computing the global difference between remaining portions in each pair of images.

11. The system of claim 8, the operations further comprising:
evaluating the image generation qualities of the plurality of checkpoints by applying a scoring function that accounts for the subject similarity and the global difference between each pair of images.

12. The system of claim 11, wherein the scoring function is represented by
$$\frac{1}{N \times M} {\sum }_{i = 1}^{N} {\sum }_{j = 1}^{M} [ α {S}_{0} ( i , j ) + ( 1 - α ) Δ {S}_{g} ( i , j ) ] ,$$
wherein N represents a quantity of images in the plurality of subject images generated by each of the plurality of checkpoints, M represents a quantity of images in the set of training images, S₀ represents the subject similarity between images in each pair of images, ΔS_{g} represents the global difference between images in each pair of images, and a represented a constant.

13. The system of claim 11, the operations further comprising:
generating a plurality of scores corresponding to the plurality of checkpoints;
ranking the plurality of checkpoints based on the plurality of scores.

14. The system of claim 11, the operations further comprising:
automatically identifying the checkpoint of the machine learning model with a highest score for deployment.

15. A non-transitory computer-readable storage medium, storing computer-readable instructions that upon execution by a processor cause the processor to implement operations comprising:
generating a plurality of checkpoints during training the machine learning model for subject identity preservation while preventing overfitting, wherein the plurality of checkpoints represents a plurality of versions of the machine learning model, wherein the machine learning model is trained on a set of training images, and wherein the set of training images depict a particular subject;
generating a plurality of subject images by each of the plurality of checkpoints;
computing subject similarity and global difference between images in each pair of images, wherein each pair of images comprises one of the set of training images and one of the plurality of subject images generated by each of the plurality of checkpoints;
evaluating image generation qualities of the plurality of checkpoints based on the subject similarity and the global difference between images in each pair of images; and
automatically identifying the checkpoint of the machine learning model from the plurality of checkpoints for deployment based on the evaluated image generation qualities of the plurality of checkpoints.

16. The non-transitory computer-readable storage medium of claim 15, the operations further comprising:
detecting the particular subject in each pair of images; and
computing the subject similarity of the particular subject in each pair of images.

17. The non-transitory computer-readable storage medium of claim 15, the operations further comprising:
removing the particular subject from each pair of images; and
computing the global difference between remaining portions in each pair of images.

18. The non-transitory computer-readable storage medium of claim 15, the operations further comprising:
evaluating the image generation qualities of the plurality of checkpoints by applying a scoring function that accounts for the subject similarity and the global difference between each pair of images.

19. The non-transitory computer-readable storage medium of claim 11, the operations further comprising:
generating a plurality of scores corresponding to the plurality of checkpoints;
ranking the plurality of checkpoints based on the plurality of scores.

20. The non-transitory computer-readable storage medium of claim 11, the operations further comprising:
automatically identifying the checkpoint of the machine learning model with a highest score for deployment.
